(19) United States
(12) Patent Application Publication
(10) Pub. No.: US 2016/0168905 A1
(43) Pub. Date: Jun. 16, 2016

(54) MULTI-STAGE SUNSHADE DEVICE

(71) Applicant: OME TECHNOLOGY CO., LTD., NEW TAIPEI CITY (TW)

(72) Inventors: KUO-FU LIAO, TAIPEI CITY (TW); SHI-HWA LO, TAIPEI CITY (TW); KUN-FEI LI, TAIPEI CITY (TW); CHIEN-HSIANG MIAO, TAIPEI CITY (TW)

(21) Appl. No.: 14/644,496

(22) Filed: Mar. 11, 2015

(30) Foreign Application Priority Data
Dec. 10, 2014 (TW) 103143166

(51) Int. Cl. E06B 9/302; E06B 9/38; E06B 9/327

(52) U.S. Cl. CPC E06B 9/302; E06B 9/327; E06B 9/38; E06B 2009/2458

(57) ABSTRACT

A multi-stage sunshade device includes two fixed frames, two first operable frames, two second operable frames, multiple first operable blades, a first lined module, a second linked module, and multiple second operable blades. The two fixed frames, two first operable frames, and two second operable frames cooperatively define a main window plane, a first window plane, and a second window plane. The first operable blades and the second operable blades selectively cover the first and the second window planes via the two first and two second linked modules. Two first operable frames and two second operable frames each having two ends, one end of each is coupled to one another, while the other end of each is coupled to the guiding rails on the two fixed frames, so that the two first and two second operable frames can be proximate to or distal from one another.

### BACKGROUND OF THE INVENTION

1. Field of the Invention

The instant disclosure relates to a sunshade device having a plurality of operable frames and operable blades; in particular, to a multi-stage sunshade device.

2. Description of Related Art

Ventilation and lighting in modern architecture typically provides windows in almost every room, especially glass curtain walls that provide views overlooking the outdoor landscape. When sunlight is rather intense, such window designs are likely to rise the indoor temperature that can cause discomfort or compromise privacy among occupants, making blinds the prevalent choice to be installed on windows in order to shield sunshine or provide privacy.

However, current blinds are limited to only a few choices that provide either complete coverage or angle adjustments of blind blades that control the amount of incident light, yet still cannot meet all application demands.

To address the above issues, the inventor strives via associated experience and research to present the instant disclosure, which can effectively improve the limitation described above.

### SUMMARY OF THE INVENTION

The objective of the instant disclosure is to provide a multi-stage sunshade device to resolve the issue above.

In order to achieve the aforementioned objectives, according to an embodiment of the instant disclosure, a multi-stage sunshade device is provided. The multi-stage sunshade device includes two fixed frames, two first operable frames, two second operable frames, a plurality of first operable blades, a first linked module, a plurality of second operable blades, and a second linked module. The two fixed frames are arranged to face one another to define a main window plane, and each fixed frame has a guiding rail. The two first operable frames are arranged to face one another to define a first window plane, each first operable frame has two ends defined as a first guiding end and a first pivotable end, and two of the first guiding ends are pivotably connected into the guiding rails of the two fixed frames. The two second operable frames are arranged to face one another to define a second window plane, each second operable frame has two ends defined as a second pivotable end and a first guiding end, two of the second pivotable ends are pivotably connected to two of the first pivotable ends, and two of the guiding ends are pivotably connected into the guiding rails of the two fixed frames. Each first operable blade has two ends respectively and pivotably connected to two first operable frames. The first linked module is connected to the plurality of first operable blades and synchronously rotates with the plurality of first operable blades in identical directions so that the first operable blades can selectively cover the first window plane. Each second operable blade has two ends respectively and pivotably connected to two second operable frames. The second linked module is connected to the plurality of second operable blades and synchronously rotates with the plurality of second operable blades in identical directions so that the second operable blades can selectively cover the second window plane. Two first guiding ends and two corresponding second guiding ends can be proximate or distal to one another along the two guiding rails, so that the first operable blades and second operable blades of the first operable frame and second operable frame can selectively cover the main window plane.

The instant disclosure provides the following improvements. The operable blades can selectively cover the first window plane according to the user's needs, while the second operable blades can still selectively cover the second window plane as needed, whereas the first operable frames and the second operable frames can selectively move with respect to the two fixed frames as needed. With the flexible operability of the first and second operable blades in conjunction with the first and second operable frames, multiple modes of sun shading can be provided.

In order to further understand the instant disclosure, the following embodiments and illustrations are provided. However, the detailed description and drawings are merely illustrative of the disclosure, rather than limiting the scope being defined by the appended claims and equivalents thereof.

### BRIEF DESCRIPTION OF THE DRAWINGS

FIG. 1 is an exploded view of a multi-stage sunshade device in accordance with the instant disclosure;

FIG. 2 is an assembled view of the multi-stage sunshade device in accordance with the instant disclosure;

FIG. 3 is a schematic diagram illustrating a possible position of operable frames in accordance with the multi-stage sunshade device of the instant disclosure;

FIG. 4 is another schematic diagram illustrating another possible position of the operable frames in accordance with the multi-stage sunshade device of the instant disclosure;

FIG. 5 is a schematic diagram illustrating a possible position of operable blades in accordance with the multi-stage sunshade device of the instant disclosure;

FIG. 6 is another schematic diagram illustrating another possible position of the operable blades in accordance with the multi-stage sunshade device of the instant disclosure; and

FIG. 7 is a schematic diagram of the multi-stage sunshade device in accordance with an embodiment of the instant disclosure.

### DETAILED DESCRIPTION OF THE PREFERRED EMBODIMENTS

The aforementioned illustrations and detailed descriptions are exemplarity for the purpose of further explaining the scope of the instant disclosure. Other objectives and advantages related to the instant disclosure will be illustrated in the subsequent descriptions and appended drawings.

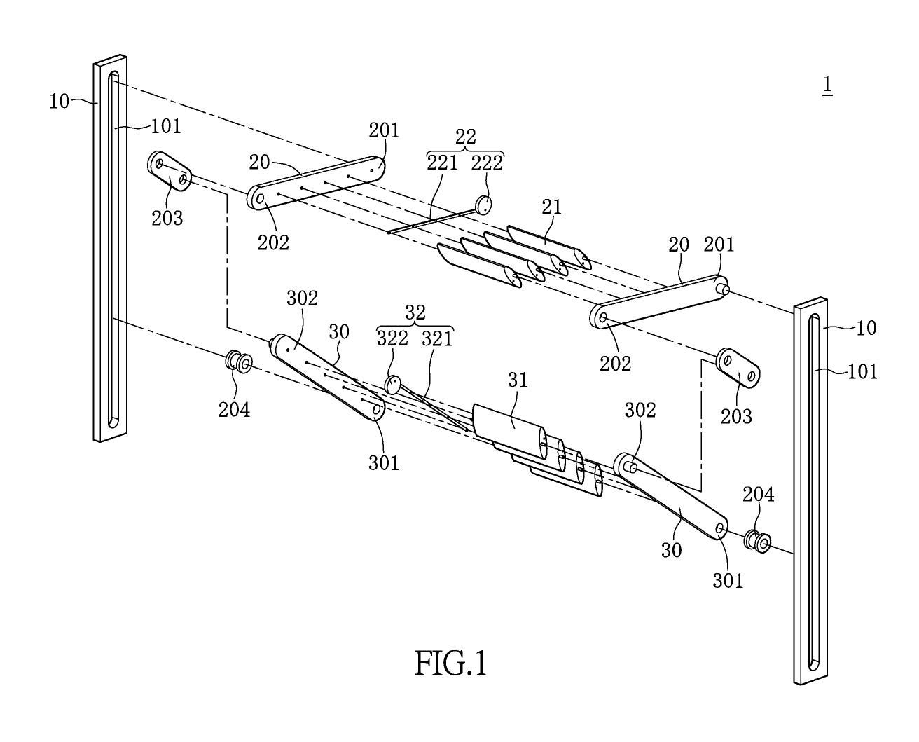

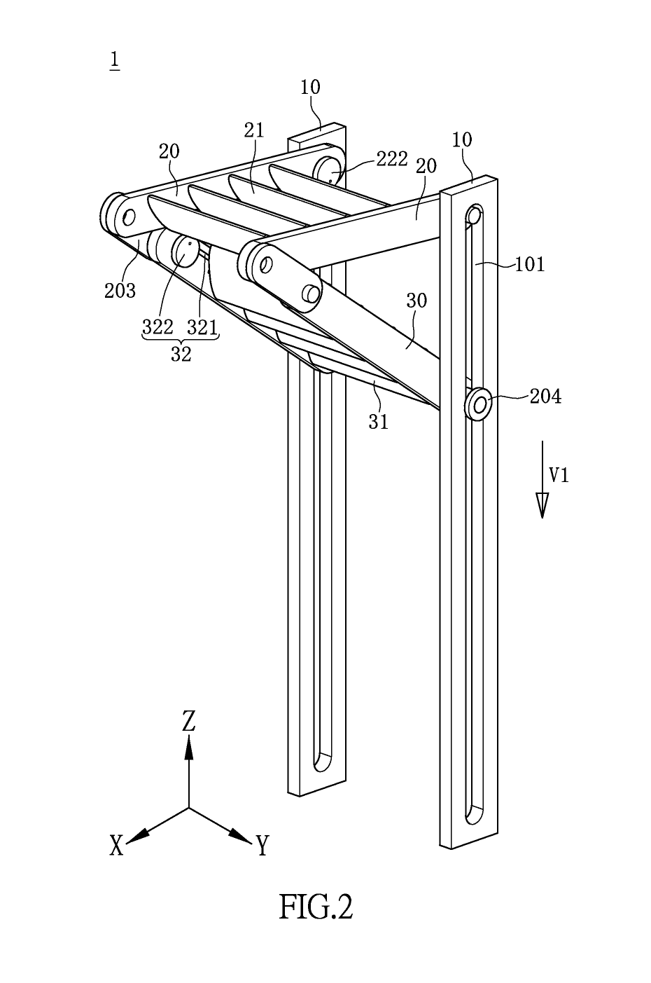

Please refer to FIGS. 1 and 2 which are exploded and assembled views of the multi-stage sunshade device in accordance with the instant disclosure. The multi-stage sunshade device 1 includes two fixed frames 10, two first operable frames 20, two second operable frames 30, a plurality of first operable blades 21, a first linked module 22, a plurality of second operable blades 31, and a second linked module 32. Two fixed frames 10 are arranged to face one another to define a main window plane (Y-Z plane of the axis as shown in FIG. 2). Each fixed frame 10 has a guiding rail 101. The guiding rail 101 can be of any shape or form, such as a linear guiding rail, a through opening as shown in the figures, or in a similar manner.

Two first operable frames 20 are arranged to face one another to define a first window plane (not labeled). Each first operable frame 20 has two ends, in which the two ends are defined as a first guiding end 201 and a first pivotable end 202. Two first guiding ends 201 of the two first operable frames 20 are pivotably arranged and moved in the guiding rails 101 of the two fixed frames 10.

Two second operable frames 30 are arranged to face one another to define a second window plane (not labeled). Each second operable frame 30 has two ends, in which two ends are defined as a second guiding end 301 and a second pivotable end 302. Two second guiding ends 301 of the two second operable frames 30 are pivotably arranged and moved in the guiding rails 101 of the two fixed frames 10. The two second pivotable ends 302 of the two second operable frames 30 are pivotably connected to two first pivotable ends 202 of the two first operable frames 20. Each of the first guiding ends 201 and each of the second guiding ends 301 are pivotably connected in the guiding rail 101 via a supplementary guiding member 204, such as rollers, linear sliding blocks, etc. Two first pivotable ends 202 can be pivotably connected to two second pivotable ends 302 via two supplementary pivoting members 203, but the invention is not limited hereto.

In other words, after two first operable frames 20 and two second operable frames 30 are mutually and pivotally connected, another side of each first operable frame 20 and another side of each second operable frame 30 not mutually connected (the first guiding end 201 and the second guiding end 301) are respectively and pivotably connected to the two fixed frames 10. As a result, two first guiding ends 201 can be proximate to or distal to the corresponding two second guiding ends 301 within the two guiding rails 101. Moreover, the two first operable frames 20 and two second operable frames 20 that are coupled to one another can selectively change the angle between the first window plane and the second window plane.

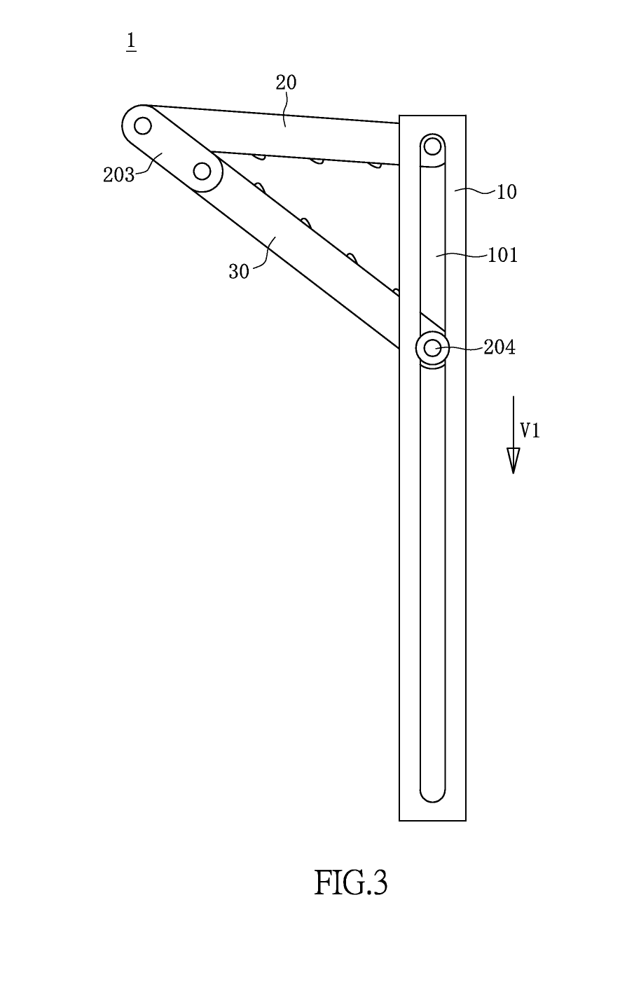

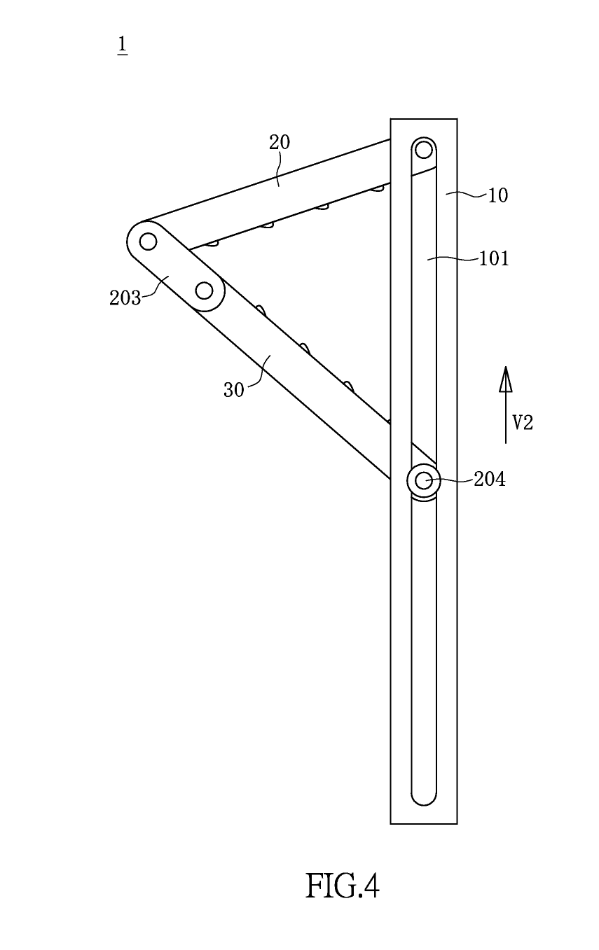

Specifically, as shown in FIGS. 3 and 4, when two first guiding ends 201 of the two first operable frames 20 are fixed at one end of the fixed frame 10, two second guiding ends 301 (please refer to FIG. 1) of two operable frames 30 can move along the guiding rail 101 towards a first movable direction V1 or a second movable direction V2 to change the angle between the connected second operable frame 30 and the first operable frame 20. When two first guiding ends 201 and the two second guiding ends 301 are arranged on separate ends of the two guiding rails 101, two first operable frames 20 and two second operable frame 30 are respectively adjusted to an angle of about 180 therebetween. When the two first guiding ends 201 and the two second guiding ends 301 are arranged closest to one another on the guiding rail 101, two first operable frames 20 and two second operable frames 30 are respectively adjusted to an acute angle therebetween.

Two ends of the first operable blades 21 can be respectively coupled to the corresponding inner sides of two first operable frames 20. The first linked module 22 can be connected to the first operable blades 21, so that the first operable blades 21 can synchronously rotate towards the same direction, and the first operable blades 21 can selectively cover the first window plane. Similarly, two ends of the first operable blades 21 can be respectively coupled to the corresponding inner sides of two second operable frames 30. The second linked module 32 can be connected to the second operable blades 31, so that the second operable blades 31 can synchronously rotate towards the same direction, and the second operable blades 31 can selectively cover the second window plane.

Specifically, the first linked module 22 can have a first linkage 221 and a first driving unit 222. The first linkage 221 can be movably arranged at the inner side of one of the first operable frames 20. A side of the first linkage 221 facing another first operable frame 20 is pivotally connected to one end of each of the first operable blades 21. One end of the first linkage 221 and the first driving unit 222 are pivotally connected, and the first linkage 221 can be driven by the first driving unit 222 to move at the inner side of the first operable frame 20. Namely, when the first driving unit 222 is driven to rotate, the first linkage 221 can be driven to move at the inner side of the first operable frame 20, so that the first operable blades 21 are also driven to synchronously rotate in the same direction and selectively cover the first window plane. The second linked module 32 can also have a second linkage 321 and a second driving unit 322. Two ends of the second operable blades 31 can be respectively coupled to the corresponding inner sides of two second operable frames 30 and the corresponding inner sides of two linkages 321. With the second linkage 321 driven to move by the second driving unit 322, the second operable blades 31 can rotate towards the same direction, and the second operable blades 31 can selectively cover the second window plane.

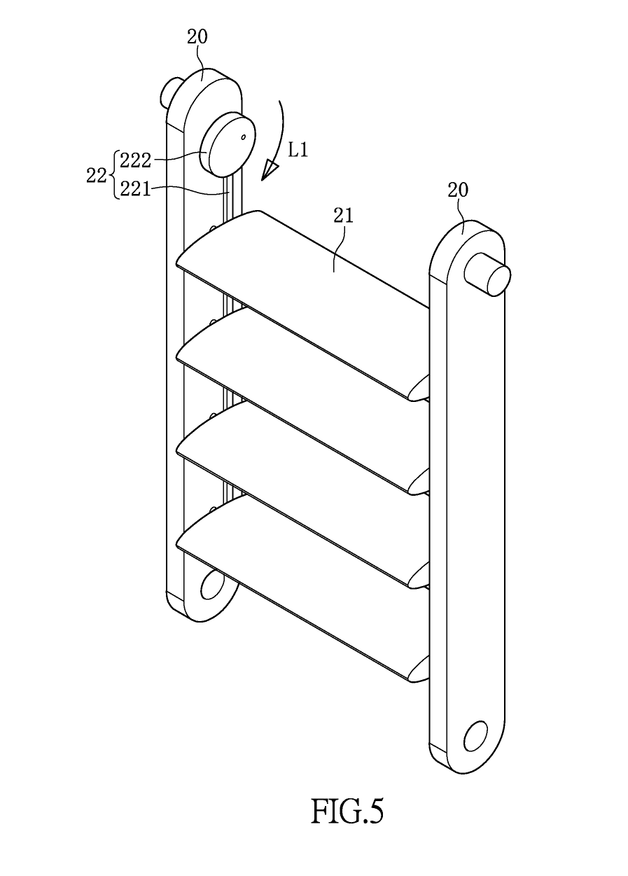

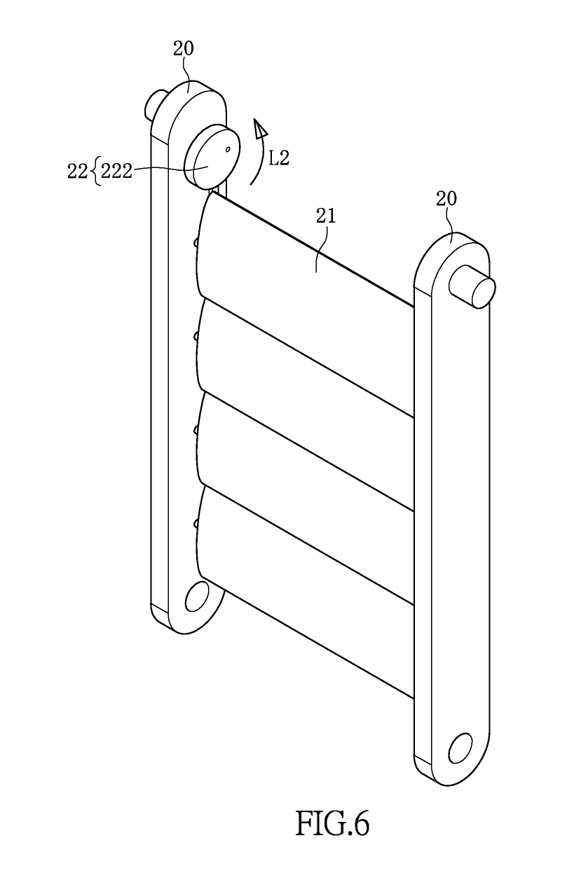

As shown in FIGS. 5 and 6, when the first driving unit 222 is driven to rotate in a first rotational direction L1, the first linkage 221 is also driven to move, so that the first operable blades 21 synchronously rotate from the mode as shown in FIG. 5 to a mode as shown in FIG. 6. On the contrary, when the first driving unit 222 rotates in a second rotational direction L2, the first linkage 221 is also driven to move, so that the first operable blades 21 synchronously rotate from the mode as shown in FIG. 6 to the mode as shown in FIG. 5.

In application, the first linked module 22 and the second linked module 32 can be mechanically connected to one another. For example, an additional driving unit (not shown) can be arranged on two separate first pivotable ends 202. The first linkage 221 and the second linkage 321 are connected to one another via the driving unit, so that the first operable blades 21 and the second operable blades 31 can synchronously rotate in the same direction by adjusting the first driving unit 222 or the second driving unit 322.

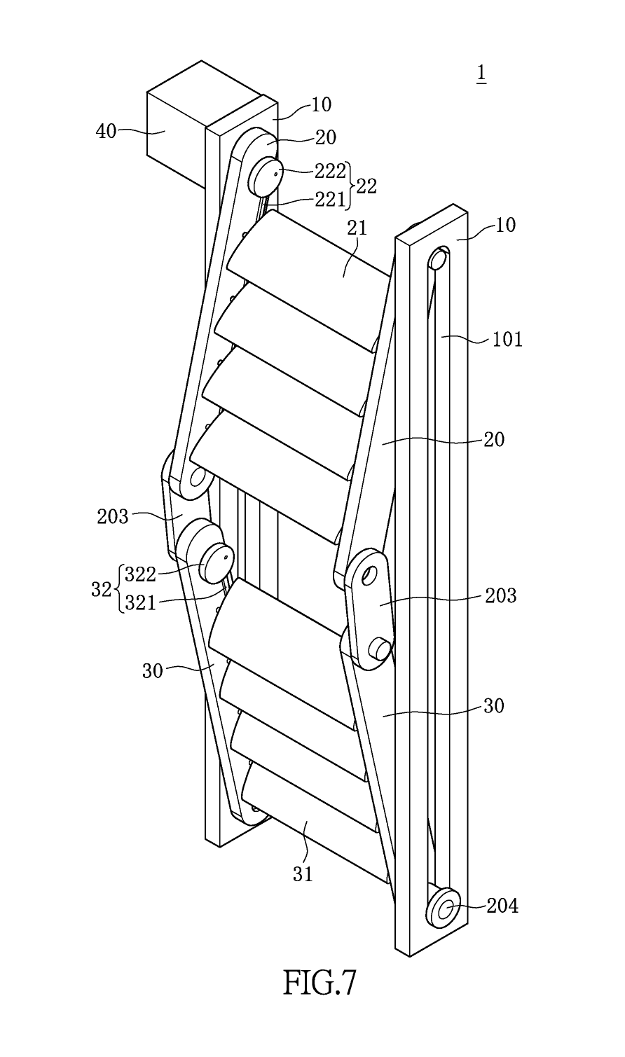

Please refer to FIG. 7 (please refer to FIG. 1 for elements and components not labeled in FIG. 7 for the descriptions hereafter). In the preferred embodiment, the multi-stage sunshade device 1 can include a driving device 40 that is mechanically connected to at least one first guiding end 201 or at least one second guiding end 301 in order to drive together or apart the two first guiding ends 201 and two second guiding ends 301. Specifically, the driving device 40 can be mechanically connected to the first guiding end 201 or the second guiding end 301 via the supplementary guiding member 204, such that the first guiding end 201 and the second guiding end 301 are mutually closer or away from each other via controlling the supplementary guiding member 204. As a result, a user can modify the surface area of the main window plane being covered via modifications to the positions of the first operable frame 20 and the second operable frame 30 with respect to the fixed frame 10.

Specifically, when the first window plane is covered with the first operable blades 21 and the second window plane is covered with the second operable blades 31, the user can change the relative positions of the first operable frame 20, the second operable frame 30, and the fixed frame 10 via the control of the driving device 40, so the state in which the main window plane is being covered can be modified as required by the user. For example, when the distance between the first guiding ends 201 and the second guiding ends 301 is at its largest, users can choose to cover the main window plane completely or partially in intervals with adjustments made to the positions of the first operable blades 21 and the second operable blades 31. When the distance between first guiding ends 201 and the second guiding ends 301 is at its smallest, a large portion of the main window plane is not covered by the first operable frames 20, the first operable blades 21, the second operable frames 30, and the second operable blades 31.

In the preferred embodiment, the driving device 40 is not only mechanically connected to the first guiding ends 201 or the second guiding ends 301, the driving device 40 can also be mechanically connected to the first linked module 22 and the second linked module 32. Consequently, a user can simultaneously control the first operable frame 20, the second operable frame 30, the first linked module 22, and the second linked module 32 to provide various modes of coverage. Moreover, the user can also separately control the first operable frame 20, the second operable frame 30, the first linked module 22, and the second linked module 32 to further accommodate the users' needs. For example, the driving device 40 can control the first linked module 22 and the second linked module when the distance between two first guiding ends 201 and the corresponding two second guiding ends 301 are closest to one another, so that the first operable blades 21 and the second operable blades 31 demonstrate a mode that covers the first window plane and the second window plane, which facilitates the two first operable frames 20 and the two second operable frames 30 to collapse to the smallest possible volume.

Notably, the first operable frame 20 and the second operable frame 30 can be made from relatively strong materials that can withstand a locking device to be disposed over the first operable frame 20, the second operable frame 30, and the fixed frame 10. The multi-stage sunshade device of the instant disclosure not only provides multiple sun-shading or covering modes as needed to completely cover the main window plane with the first operable frame 20 and the second operable plane 30, but also provides security along with the locking device that optionally locks together the operable frames with the fixed frame 10.

The figures and descriptions supra set forth illustrate the preferred embodiments of the instant disclosure; however, the characteristics of the instant disclosure are by no means restricted thereto. All changes, alterations, combinations or modifications conveniently considered by those skilled in the art are deemed to be encompassed within the scope of the instant disclosure delineated by the following claims.

What is claimed is:

1. A multi-stage sunshade device, comprising:
two fixed frames arranged to face one another to define a main window plane, and each fixed frame having a guiding rail;
two first operable frames arranged to face one another to define a first window plane, each first operable frame having two ends defined as a first guiding end and a first pivotable end, and two of the first guiding ends pivotably connected to the guiding rails of the two fixed frames;
two second operable frames arranged to face one another to define a second window plane, each second operable frame having two ends defined as a second pivotable end and a first guiding end, two of the second pivotable ends pivotably connected to two of the first pivotable ends, and two of the guiding ends pivotably connected to the guiding rails of the two fixed frames;
a plurality of first operable blades, each having two ends respectively and pivotably connected to two sides of two first operable frames arranged to face one another;
a first linked module connected to the plurality of first operable blades and synchronously rotating the plurality of first operable blades in identical directions so that the first operable blades are selectively covering the first window plane;
a plurality of second operable blades, each having two ends respectively and pivotably connected to two sides of two second operable frames arranged to face one another; and
a second linked module connected to the plurality of second operable blades and synchronously rotating the plurality of second operable blades in identical directions so that the second operable blades are selectively covering the second window plane;
wherein two of the first guiding ends are proximate or distal to two corresponding second guiding ends, so that the first operable blades and second operable blades of the first operable frame and second operable frame selectively cover the main window plane.

2. The multi-stage sunshade device as recited in claim 1, wherein the first linked module includes at least one first linkage and one first driving unit, the first linkage is movably arranged at a side of one of the first operable frames facing another first operable frame, one end of each of the first operable blades is pivotably connected to the first operable frame via the first linkage, the first driving unit and the first linkage are connected to one another so that the first operable blades are rotatable in identical directions and selectively cover the first window plane.

3. The multi-stage sunshade device as recited in claim 2 further comprising:
a driving device mechanically connected to at least one first guiding end or at least one second guiding end to drive the first guiding ends proximate or distal to the corresponding second guiding ends.

4. The multi-stage sunshade device as recited in claim 3, wherein the driving device is mechanically connected to the first linked module and the second linked module to drive the first operable blades and the second operable blades towards identical directions when the first guiding ends are proximate or distal to the corresponding second guiding ends.

5. The multi-stage sunshade device as recited in claim 4, wherein the driving device drives the first operable blades and the second operable blades to respectively cover the first window plane and the second window plane via the first linked module and the second linked module when the first driving ends and the second driving ends are arranged closest to one another.

6. The multi-stage sunshade device as recited in claim 1, wherein the second linked module includes at least a second linkage and a second driving unit, the second linkage is movably arranged on a side of one of the second operable frames facing another second operable frame, one end of each of the second operable blades is pivotably connected to the second operable frame via the second linkage, the second driving unit and the second linkage are connected to one another so that the second operable blades are rotatable in identical directions and selectively cover the second window plane.

7. The multi-stage sunshade device as recited in claim 6 further comprising:
a driving device mechanically connected to at least one first guiding end or at least one second guiding end to drive the first guiding ends proximate or distal to the corresponding second guiding ends.

8. The multi-stage sunshade device as recited in claim 7, wherein the driving device is mechanically connected to the first linked module and the second linked module to drive the first operable blades and the second operable blades towards identical directions when the first guiding ends are proximate or distal to the corresponding second guiding ends.

9. The multi-stage sunshade device as recited in claim 8, wherein the driving device drives the first operable blades and the second operable blades to respectively cover the first window plane and the second window plane via the first linked module and the second linked module when the first driving ends and the second driving ends are arranged closest to one another.

10. The multi-stage sunshade device as recited in claim 1 further comprising:
two supplementary pivoting members and two supplementary guiding members, the two supplementary pivoting members couple the two first pivotable ends to two second pivotable ends, and the two supplementary guiding members couple the two first guiding members to the two second guiding members.
